(19) United States
(12) Patent Application Publication
(10) Pub. No.: US 2009/0273289 A1
(43) Pub. Date: Nov. 5, 2009

(54) LED Light String for Decoration with Units having Replaceable LED and Housing

(76) Inventors: Ching-cherng Sun, Jhongli City (TW); Che-chih Hsu, Jhongli City (TW); Chang-yu Tsai, Jhongli City (TW)

Correspondence Address: HDLS Patent & Trademark Services, P.O. BOX 220746, CHANTILLY, VA, 20153-0746, US

(21) Appl. No.: 12/200,454

(22) Filed: Aug. 28, 2008

(30) Foreign Application Priority Data
May 5, 2008 (TW) 097116536

(51) Int. Cl. F21S 4/00

(52) U.S. Cl. 315/185 S

(57) ABSTRACT

A lamp unit includes a power cord having a mating plug at one end and a corresponding mating plug at the other end, a bulb seat, an LED holder, an LED, and a housing. The LED is mounted on the LED holder in a watertight fashion and the LED holder is mounted on the bulb seat in a watertight fashion so as to prevent water from getting in the bulb seat. The LED can be replaced with another LED capable of emitting light of different color. The housing can be replaced with another housing of different shape. The corresponding mating plug of one lamp unit is adapted to connect to the mating plug of another lamp unit so as to form an LED light string for decoration of any desired length. The invention is highly adaptable to be employed in different environments and events.

### BACKGROUND OF THE INVENTION

1. Field of Invention

The invention relates to LED lamps and more particularly to an LED light string for decoration including one or more units having an LED adapted to be replaced by another LED of different color, and a housing adapted to be replaced by a housing of different shape. Moreover, either plug of the unit can be connected to a corresponding one of the two plugs of another unit such that the LED light string can have any desired length. In addition, the LED holder is mounted in a watertight fashion on the bulb seat so as to prevent water from getting in the bulb seat to cause short circuit.

2. Description of Related Art

Decorative lamps are widely used in festivals or events. Typically, the decorative lamps are mounted with bulbs for emitting light rays of different colors for obtaining the celebration purposes.

LEDs (light-emitting diodes) are gradually employed as light sources of decorative lamps in recent years due to its advantageous characteristics including capable of being produced in various shapes, compact, durable, low power consumption, high thermal efficiency, high brightness, long life, safety, and recyclable.

However, typical decorative lamps having LEDs as light elements have the following drawbacks.

Color (i.e., color of emitted light rays), shape, and length of such typical decorative lamps having LEDs as light elements are fixed. Lamps for decoration with LEDs as light elements having characteristics similar to that of the invention are commercially available in Taiwan. However, housing of the LED lamp for decoration is not allowed to be replaced by another one of different size or shape. Further, one such decorative lamp is not adapted to assemble with another one to form a light string. That is, there is no way to assemble such decorative lamps as a long light string. Hence, a user has to buy a number of different decorative lamps to fulfill his or her needs. Thus, it is not cost effective, inconvenient, and not environment friendly.

Moreover, rain tends to get in the typical decorative lamps having LEDs as light elements if they are installed in an outdoor environment. Hence, short circuit may occur in the bulb seat of the decorative lamp. As a result, the useful life of the decorative lamps is shortened greatly and/or even causes injury due to electric shock.

### SUMMARY OF THE INVENTION

It is therefore one object of the invention to provide an LED light string for decoration including one or more units having an LED which can be replaced by another LED of different color, and a housing which can be replaced by a housing of different shape. Moreover, either plug of the unit can be connected to a corresponding one of the two plugs of another unit such that the LED light string can have any desired length depending upon applications. Hence, the invention is highly adaptable and environment friendly.

One aspect of the invention is that the LED is mounted on the LED holder in a watertight fashion and the LED holder is also mounted on the bulb seat in a watertight fashion so as to prevent water from getting in the bulb seat. Otherwise, short circuit may occur in the LED light string. This can eliminate the drawback of the bulb seat of the well known LED lamp for decoration of being prone to damage.

The above and other objects, features and advantages of the invention will become apparent from the following detailed description taken with the accompanying drawings.

### BRIEF DESCRIPTION OF THE DRAWINGS

FIG. 1 is an exploded view of a unit of an LED light string for decoration according to the invention;

FIG. 2 is a side elevation of the assembled unit; and

FIG. 3 is a side elevation of an LED light string formed by assembling the units.

### DETAILED DESCRIPTION OF THE INVENTION

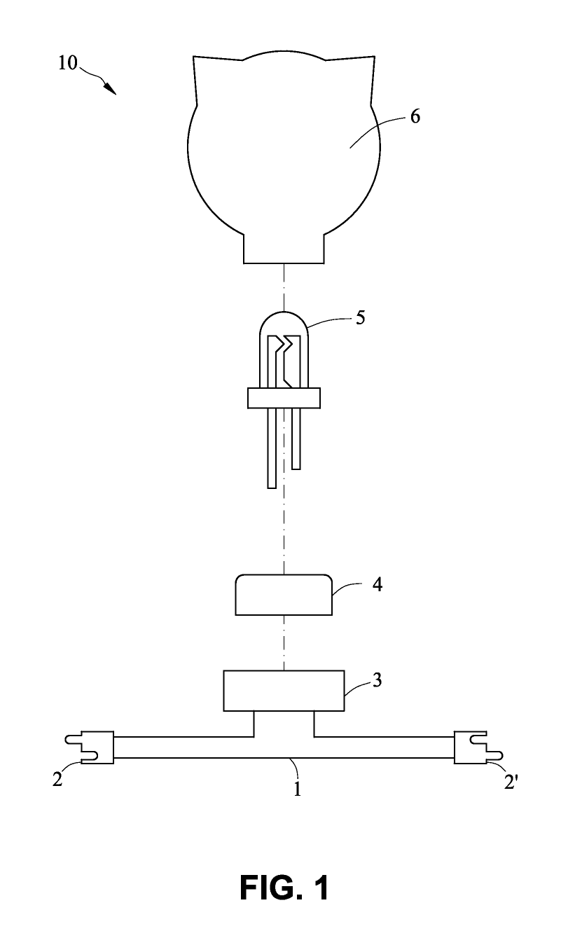

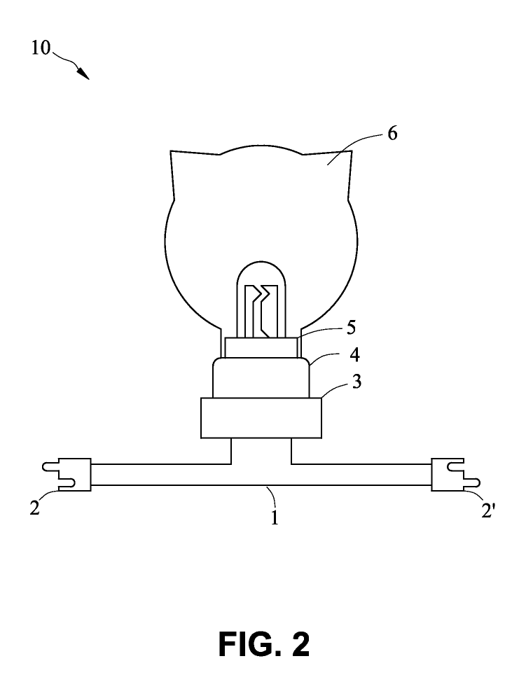

Referring to FIGS. 1 and 2, one of a plurality of units 10 of an LED light string for decoration in accordance with the invention is shown. The unit 10 comprises the following components.

A power cord 1 is adapted to electrically interconnect a power source and the unit 10. The power cord 1 has a mating plug 2 at one end and a corresponding mating plug 2′ at the other end. It is noted that each of the mating plug 2 and the corresponding mating plug 2′ can be inserted into, for example, a power strip for obtaining power therefrom.

A bulb seat 3 is provided with the power cord 1 extended therefrom. A LED holder 4 is mounted on the bulb seat 3 in a watertight fashion. An LED 5 is also mounted on the LED holder 4 in a watertight fashion. A housing 6 is also mounted on the LED holder 4 in a watertight fashion with the LED 5 being enclosed therein. This arrangement can prevent water from getting in the bulb seat. Otherwise, short circuit may occur in the unit 10.

Advantageously, the LED 5 of the unit 10 can be replaced with another LED of different color (i.e., color of emitted light rays). Further, the housing 6 of the unit 10 can be replaced with another housing of different shape.

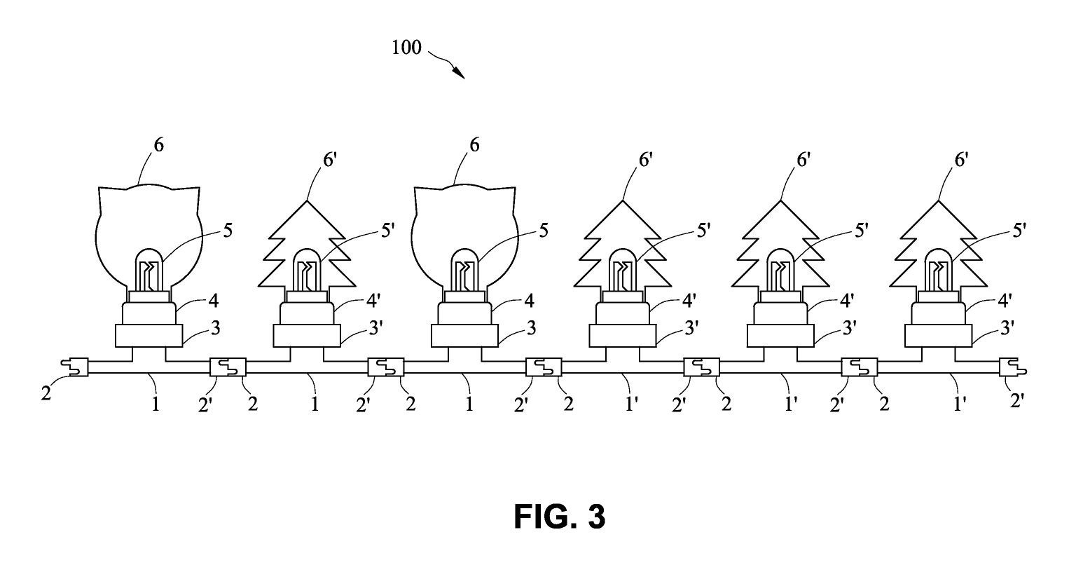

Referring to FIG. 3, an LED light string 100 formed by assembling the above units according to the invention is illustrated. The bulb seats 3, 3′ are mounted along the power cords 1, 1′ in a spaced fashion. As shown, the LED 5 of each of two units is adapted to emit red light and the LED 5′ of each of four units is adapted to emit blue light. Further, the housing 6 of each of the two units is shaped as a cat′ head and the housing 6′ of each of the four units is shaped as a Christmas tree.

Furthermore, the corresponding mating plug 2′ of the unit with an LED 5 capable of emitting red light and a housing 6 shaped as a cat's head can be matingly connected to the mating plug 2 of the unit with an LED 5′ capable of emitting blue light and a housing 6′ shaped as a Christmas tree.

Moreover, the corresponding mating plug 2′ of the unit with an LED 5′ capable of emitting blue light and a housing 6′ shaped as a Christmas tree can be matingly connected to the mating plug 2 of the unit with an LED 5′ capable of emitting blue light and a housing 6′ shaped as a Christmas tree.

As a result, an LED light string 100 of increased length is assembled. It is contemplated by the invention that an LED light string of any desired length can be assembled so as to be employed in a specific event depending on applications.

The invention has the following advantages including capable of being produced in various shapes, compact, durable, low power consumption, high thermal efficiency, high brightness, long life, safety, and recyclable.

While the invention herein disclosed has been described by means of specific embodiments, numerous modifications and variations could be made thereto by those skilled in the art without departing from the scope and spirit of the invention set forth in the claims.

What is claimed is:

1. An light-emitting diode (LED) light string for decoration, comprising:
a power cord adapted to electrically connect to a power source;
one or more bulb seats mounted on the power cord in a spaced fashion;
one or more LED holders each sealingly mounted on the bulb seat;
one or more LEDs each releasably mounted on the LED holder and electrically connected to the power source via the bulb seat and the LED holder; and
one or more housings each releasably mounted on the LED.

2. The LED light string of claim 1, wherein the power cord has a mating plug at one end and a corresponding mating plug at the other end, the corresponding mating plug being adapted to connect to the mating plug.

3. The LED light string of claim 1, wherein the LED holder is sealingly mounted on the bulb seat in a watertight fashion.

4. The LED light string of claim 1, wherein the LED is adapted to be replaced with another LED capable of emitting light of different color.

5. The LED light string of claim 1, wherein the housing is adapted to be replaced with another housing of different shape.

6. The LED light string of claim 1, wherein the housing is sealingly mounted on the LED holder with the LED being enclosed therein.

7. An LED light string for decoration comprising:
a power cord adapted to electrically connect a power source and having a mating plug at one end and a corresponding mating plug at the other end, the corresponding mating plug being adapted to connect to the mating plug;
one or more bulb seats mounted on the power cord in a spaced fashion;
one or more LED holders each sealingly mounted on the bulb seat; and
one or more LEDs each sealingly mounted on the LED holder and electrically connected to the power source via the bulb seat and the LED holder.

8. The LED light string of claim 7, wherein the LED holder is sealingly mounted on the bulb seat in a watertight fashion.

9. The LED light string of claim 7, wherein the LED is releasable and further comprising one or more housings each releasably mounted on the LED.

10. The LED light string of claim 9, wherein the LED is adapted to be replaced with another LED capable of emitting light of different color, and wherein the housing is adapted to be replaced with another housing of different shape.

11. The LED light string of claim 9, wherein the housing is sealingly mounted on the LED holder with the LED being enclosed therein.
